(19) United States
(12) Patent Application Publication
(10) Pub. No.: US 2025/0220298 A1
(43) Pub. Date: Jul. 3, 2025

(54) CONTROL SYSTEM AND UNIT, IMAGE CAPTURING SYSTEM AND APPARATUS, INFORMATION PROCESSING APPARATUS, CONTROL METHOD, AND STORAGE MEDIUM

(71) Applicant: CANON KABUSHIKI KAISHA, Tokyo (JP)

(72) Inventor: KOTOMI KAKIUCHI, Tokyo (JP)

(21) Appl. No.: 18/985,792

(22) Filed: Dec. 18, 2024

(30) Foreign Application Priority Data
Dec. 28, 2023 (JP) 2023-223263

(51) Int. Cl. H04N 23/60; G06F 3/16

(52) U.S. Cl. CPC H04N 23/64; G06F 3/165

(57) ABSTRACT

A control system that controls shooting timing of an image to be recorded by an image capturing apparatus, comprises: an image analysis unit that analyzes images obtained by the image capturing apparatus performing shooting repeatedly; an audio analysis unit that analyzes audio collected by an audio collection unit; and a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.

### BACKGROUND OF THE INVENTION

### Field of the Invention

The present invention relates to a control system and unit, an image capturing system and apparatus, an information processing apparatus, a control method, and a storage medium, and in particular to a technique for automatically controlling image shooting timing.

### Description of the Related Art

There is provided an image capturing apparatus that continuously captures images without a user giving a shooting instruction. As a technology related to such an image capturing apparatus, for example, Japanese Patent No. 6766086 discloses a technology related to an image capturing apparatus that allows a user to obtain a desired image without the user performing a special operation. Japanese Patent No. 6766086 discloses a technique that analyzes preview images and performs shooting when it is determined that a subject is currently present within an angle of view.

However, the shooting judgment based solely on image analysis as disclosed in Japanese Patent No. 6766086 has the problem that it is not possible to recognize whether the place is lively or whether the conversation is lively, and therefore there is a possibility of missing a moment when should be shot.

### SUMMARY OF THE INVENTION

The present invention has been made in consideration of the above situation, and prevents an opportunity to shoot a scene from being missed without a user performing any special operations on the image capturing apparatus.

According to the present invention, provided is a control system that controls shooting timing of an image to be recorded by an image capturing apparatus, comprising one or more processors and/or circuitry which function as: an image analysis unit that analyzes images obtained by the image capturing apparatus performing shooting repeatedly; an audio analysis unit that analyzes audio collected by an audio collection unit; and a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.

Further, according to the present invention, provided is an image capturing system comprising: a control apparatus that includes an audio analysis unit that analyzes audio collected by an audio collection unit; an image capturing apparatus that includes: an image sensor that shoots an image; an image analysis unit that analyzes images obtained by the image sensor performing shooting repeatedly; and a control unit that determines whether or not to shoot an image to be recorded based on an image analysis result obtained by the image analysis unit and an audio analysis result by the audio analysis unit, and instructs the image sensor to shoot an image to be recorded if it is determined that an image should be shot, and a communication unit that communicates between the image capturing apparatus and the control apparatus, wherein the audio analysis unit, the image analysis unit, and the control unit are implemented by one or more processors, circuitry or a combination thereof.

Furthermore, according to the present invention, provided is a control unit that controls shooting timing of an image to be recorded by an image capturing apparatus, comprising one or more processors and/or circuitry which function as: an image analysis unit that analyzes images obtained by the image capturing apparatus performing shooting repeatedly; an audio analysis unit that analyzes audio collected by an audio collection unit; and a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.

Further, according to the present invention, provided is an image capturing apparatus comprising: an image sensor that shoots an image; and a control unit that controls shooting timing of an image to be recorded by the image capturing apparatus, comprising one or more processors and/or circuitry which function as: an image analysis unit that analyzes images obtained by the image capturing apparatus performing shooting repeatedly; an audio analysis unit that analyzes audio collected by an audio collection unit; and a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.

Further, according to the present invention, provided is an information processing apparatus comprising: a control unit that controls shooting timing of an image to be recorded by an image capturing apparatus, comprising one or more processors and/or circuitry which function as: an image analysis unit that analyzes images obtained by the image capturing apparatus performing shooting repeatedly; an audio analysis unit that analyzes audio collected by an audio collection unit; and a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot, and a communication unit that communicates with the image capturing apparatus.

Further, according to the present invention, provided is a control method that controls shooting timing of an image to be recorded by an image capturing apparatus, comprising: analyzing images obtained by the image capturing apparatus performing shooting repeatedly; analyzing audio collected by an audio collection unit; and determining whether or not to shoot an image to be recorded based on the image analysis result and the audio analysis result, and instructing the image capturing apparatus to shoot an image to be recorded if it is determined that an image should be shot.

Further, according to the present invention, provided is a non-transitory computer-readable storage medium, the storage medium storing a program that is executable by the computer, wherein the program includes program code for causing the computer to function as a control system that controls shooting timing of an image to be recorded by an image capturing apparatus, comprising: an image analysis unit that analyzes images obtained by the image capturing apparatus performing shooting repeatedly; an audio analysis unit that analyzes audio collected by an audio collection unit; and a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.

Further, according to the present invention, provided is a non-transitory computer-readable storage medium, the storage medium storing a program that is executable by the computer, wherein the program includes program code for causing the computer to function as a control unit that controls shooting timing of an image to be recorded by an image capturing apparatus, comprising: an image analysis unit that analyzes images obtained by the image capturing apparatus performing shooting repeatedly; an audio analysis unit that analyzes audio collected by an audio collection unit; and a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram illustrating a configuration of an image capturing system according to an embodiment of the present invention.

FIG. 2A is a schematic diagram illustrating an appearance of an image capturing apparatus according to the embodiment.

FIG. 2B is a diagram explaining the directions of rotations.

FIG. 3 is a block diagram illustrating a functional configuration of the image capturing apparatus according to the embodiment.

FIG. 4 is a block diagram illustrating a functional configuration of an information processing apparatus according to the embodiment.

FIG. 5A is a sequence diagram illustrating an example of an operation of the image capturing system according to the embodiment.

FIG. 5B is a sequence diagram illustrating another example of an operation of the image capturing system according to the embodiment.

FIG. 5C is a sequence diagram illustrating yet another example of an operation of the image capturing system according to the embodiment.

FIG. 6 is a flowchart illustrating a first method of an audio score calculation method according to the embodiment.

FIG. 7 is a flowchart illustrating a second method of an audio score calculation method according to the embodiment.

FIG. 8 is a diagram illustrating an example of a screen configuration displayed on the information processing apparatus according to the embodiment.

FIG. 9 is a flowchart illustrating a third method of an audio score calculation method according to the embodiment.

FIG. 10 is a flowchart illustrating subject search processing according to the embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

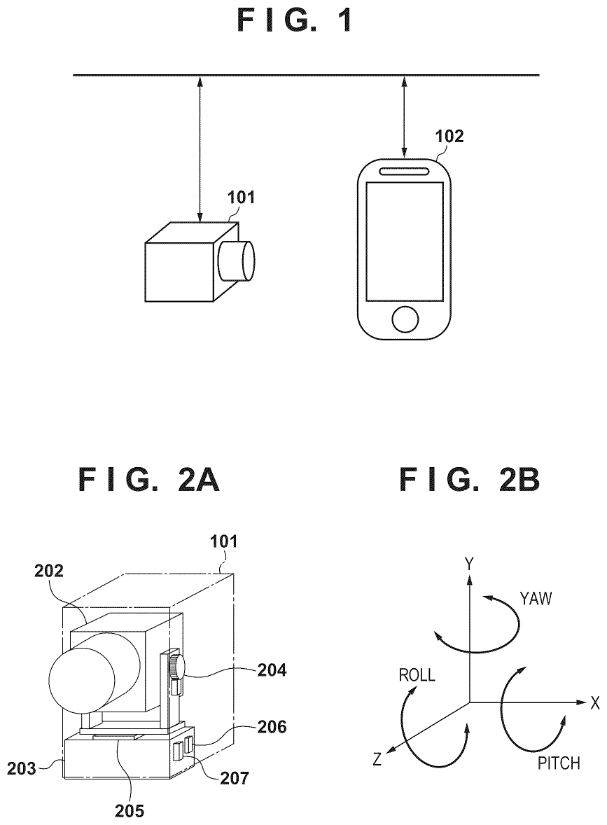

FIG. 1 is a diagram showing a configuration of an image capturing system including a control system according to the present embodiment. The image capturing system according to the present embodiment includes an image capturing apparatus 101 and an information processing apparatus 102.

In this embodiment, the image capturing apparatus 101 is, for example, an automatic shooting camera that pans, tilts, and zooms to search for a subject.

In addition, in this embodiment, a case will be described in which a smartphone terminal is used as the information processing apparatus 102. Note that, although a smartphone terminal is taken as an example of the information processing apparatus 102 here, the information processing apparatus 102 is not limited to this and may be, for example, a so-called tablet device or a personal computer. In this embodiment, the functions provided by the information processing apparatus 102 are realized in the form of an application that runs on the smartphone terminal.

FIG. 2A is a schematic diagram illustrating the external appearance of the image capturing apparatus 101, and FIG. 2B is a diagram explaining the direction of rotation.

The image capturing apparatus 101 shown in FIG. 2A is provided with an operation unit (not shown) such as buttons, switches, a touch panel, etc. for operating the camera such as a power switch. An imaging unit 202 includes a lens barrel including a group of imaging lenses as an imaging optical system, and an image sensor, and is attached to a fixed portion 203 via a pan rotation unit 205 which is a motor drive mechanism capable of rotating in the yaw direction (around the Y axis) shown in FIG. 2B.

A tilt rotation unit 204 has a motor drive mechanism that can rotate the imaging unit 202 in the pitch direction (around the X axis) shown in FIG. 2B. By actuating the pan rotation unit 205 and the tilt rotation unit 204, it is possible to change the orientation of the imaging optical system (i.e., the shooting direction), and thus, by controlling the actuation of these rotation units, it is possible to control to rotate the orientation of the imaging optical system about one or more axes.

Both angular velocity meter 206 and accelerometer 207 are mounted on the fixed portion 203 of the image capturing apparatus 101. Vibrations of the image capturing apparatus 101 are detected based on the outputs of the angular velocity meter 206 and the accelerometer 207, and the tilt rotation unit 204 and the pan rotation unit 205 are rotationally actuated based on the detected swing angle. This allows the vibration and tilt of the imaging unit 202, which is a movable part, to be corrected.

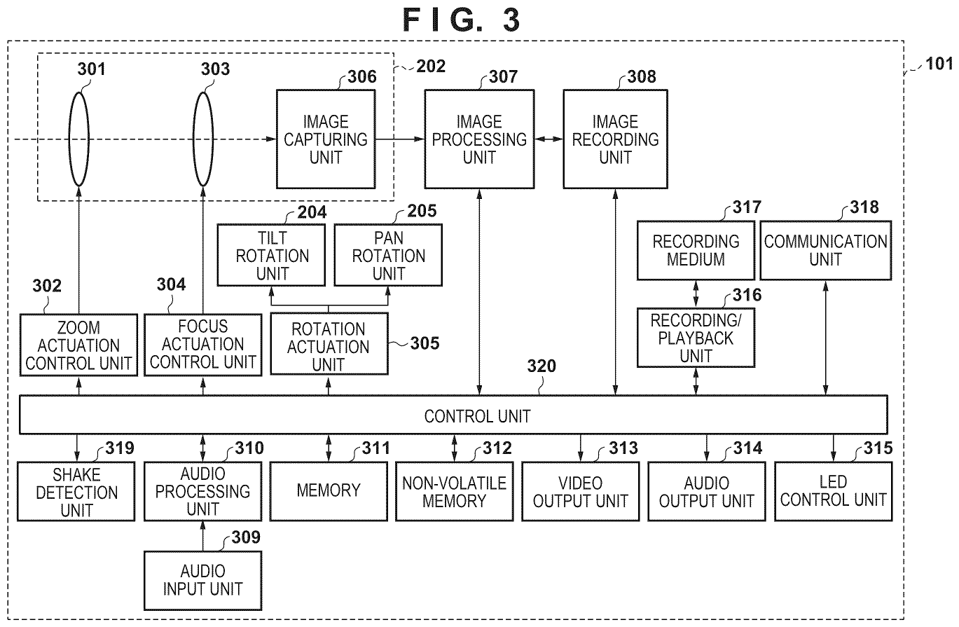

FIG. 3 is a block diagram illustrating a functional configuration of the image capturing apparatus 101 in this embodiment.

In FIG. 3, a control unit 320 is composed of a processor (e.g., a CPU, a GPU, a microprocessor, an MPU, etc.) and a memory (e.g., a DRAM, an SRAM, etc.). These execute various processes to control each block of the image capturing apparatus 101 and control data transfer between blocks. A non-volatile memory (EEPROM) 312 is an electrically erasable and recordable memory, and stores constants, programs, etc. for the operation of the control unit 320.

A zoom unit 301 includes a zoom lens that changes magnification, and is controlled and actuated by a zoom actuation control unit 302. A focus unit 303 includes a focus lens that adjusts focus, and is controlled and actuated by a focus actuation control unit 304.

An image capturing unit 306 includes an image sensor, which receives light incident through each lens group and converts it into an electric charge according to the amount of incident light. The image capturing unit 306 then converts the obtained electric charge into an analog image signal, which is then A/D converted, and outputs the obtained digital image data to an image processing unit 307. The image processing unit 307 applies image processing such as distortion correction, white balance adjustment, and color interpolation processing to the input digital image data, and outputs the processed digital image data. The digital image data output from the image processing unit 307 is converted to have a recording format such as JPEG format by an image recording unit 308, and is sent to a memory 311 and a video output unit 313.

A rotation actuation unit 305 actuates the tilt rotation unit 204 and the pan rotation unit 205 to rotate the imaging unit 202 in the tilt direction and the pan direction.

An shake detection unit 319 includes, for example, an angular velocity meter (gyro sensor) 206 that detects the angular velocity in three axial directions of the image capturing apparatus 101, and an accelerometer (acceleration sensor) 207 that detects the acceleration in three axial directions of the apparatus. The shake detection unit 319 calculates the rotation angle, shift amount, etc. of the image capturing apparatus 101 based on the detected signals.

An audio input unit 309 collects audio around the image capturing apparatus 101 from a microphone provided in the image capturing apparatus 101, converts the audio into a digital audio signal, and transmits the digital audio signal to an audio processing unit 310. The audio processing unit 310 performs audio-related processing such as optimization processing on the input digital audio signal. The digital audio signal processed by the audio processing unit 310 is then transmitted to the memory 311 under control of the control unit 320. The memory 311 temporarily stores the image data and audio signal obtained by the image processing unit 307 and the audio processing unit 310, respectively.

Furthermore, the image processing unit 307 and the audio processing unit 310 read out the image data and audio signal temporarily stored in the memory 311, and perform encoding of the image data and encoding of the audio signal, etc., to generate a compressed image signal and compressed audio signal. The control unit 320 transmits these compressed image signal and compressed audio signal to a recording/playback unit 316.

The recording/playback unit 316 records the compressed image signal, compressed audio signal, and other control data related to shooting generated by the image processing unit 307 and audio processing unit 310 on a recording medium 317. When the audio signal is not compression-encoded, the control unit 320 transmits the audio signal generated by the audio processing unit 310 and the compressed image signal generated by the image processing unit 307 to the recording/playback unit 316, which records them on the recording medium 317.

The recording medium 317 may be a recording medium built in the image capturing apparatus 101 or a removable recording medium. The recording medium 317 can record various data such as a compressed image signal, compressed audio signal, and audio signal generated by the image capturing apparatus 101, and a medium with a larger capacity than a non-volatile memory 312 is generally used as the recording medium 317. For example, the recording medium 317 includes any type of recording medium such as a hard disk, an optical disk, a magneto-optical disk, a CD-R, a DVD-R, a magnetic tape, a non-volatile semiconductor memory, a flash memory, and the like.

Furthermore, the recording/playback unit 316 reads out the compressed image signal, compressed audio signal, audio signal, various data, and programs recorded in the recording medium 317. The control unit 320 then transmits the read out compressed image signal, compressed audio signal, and audio signal to the image processing unit 307 and audio processing unit 310, respectively. The image processing unit 307 and audio processing unit 310 make the memory 311 temporarily store the compressed image signal, compressed audio signal, and audio signal, decode them in a predetermined procedure as necessary, and transmit the obtained signals to the video output unit 313 and audio output unit 314, respectively.

For example, during shooting, an audio output unit 314 outputs audio based on a preset audio pattern or an audio signal transmitted from audio processing unit 310 from a speaker built in the image capturing apparatus 101. Note that audio output unit 314 may be an audio output terminal, and in that case, transmits an audio signal to a connected external speaker.

An LED control unit 315 controls LEDs provided in the image capturing apparatus 101 to light and blink in a preset pattern during shooting, for example.

The video output unit 313 is, for example, a video output terminal, and transmits an image signal to display an image on a connected external display, etc. The audio output unit 314 and the video output unit 313 may be configured as a single combined terminal, for example, an HDMI (High-Definition Multimedia Interface) (registered trademark) terminal.

A communication unit 318 communicates between the image capturing apparatus 101 and the information processing apparatus 102, and can transmit and receive, for example, audio signals, image signals, compressed audio signals, compressed image signals, and audio scores (described later). The communication unit 318 also receives control signals related to shooting, such as a start-shooting command, end-shooting command, and pan, tilt, and zoom actuation commands, from an external device capable of intercommunicating with the image capturing apparatus 101. The communication unit 318 is, for example, a wireless communication module, such as an infrared communication module, a Bluetooth communication module, a wireless LAN communication module, a Wireless USB, or a GPS receiver.

In this embodiment, the audio input unit 309 has a configuration in which a plurality of microphones are provided on the image capturing apparatus 101, and the audio processing unit 310 can detect the direction of sound on a plane on which the plurality of microphones are set, and the obtained information is used for subject search and automatic shooting, which will be described later. Furthermore, the audio processing unit 310 detects a trigger word. A trigger word is a predetermined word that, when recognized by the audio processing unit 310, triggers shooting. Details of the trigger word will be described later.

The audio processing unit 310 also performs sound scene recognition. In sound scene recognition, a neural network that has been trained by machine learning based on a large amount of audio data in advance is used to determine the sound scene. For example, a neural network for detecting specific sound scenes such as “cheering,” “clapping,” and “vocalizing” is set in the audio processing unit 310.

When a specific sound scene or a specific trigger word is detected, a trigger detection signal is output to the control unit 320.

As described above, the image capturing apparatus 101 in this embodiment is an automatic shooting camera, and in automatic shooting, subject search processing described below is performed at a predetermined cycle using pan, tilt, and zoom, and the searched subject is automatically shot based on the image score and audio score described below.

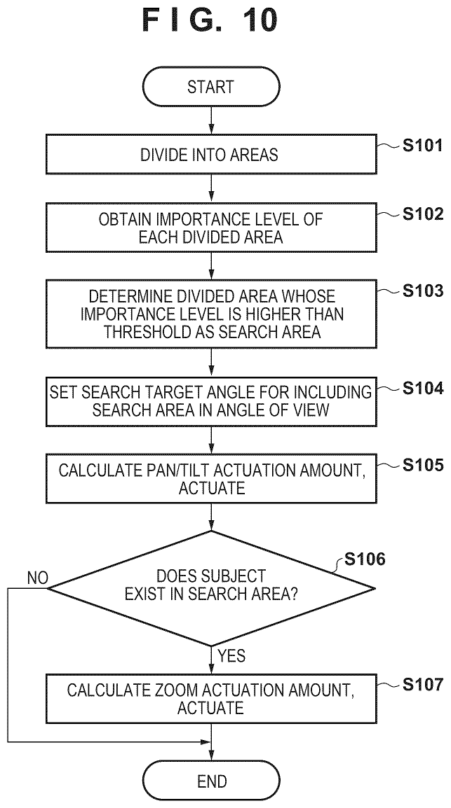

The subject search processing performed in the image capturing apparatus 101 will now be described with reference to the flowchart of FIG. 10. Note that the subject search processing is performed by the control unit 320.

First, when the subject search processing is started, in step S101, area division is performed in all directions from the position of the image capturing apparatus 101 as the center.

Next, in step S102, for each divided area, an importance level indicating the priority of searching is calculated according to the subjects present in each divided area and the scene conditions of each divided area. The importance level based on the subject conditions is calculated based on, for example, the number of subjects present in each divided area, the size of the face, the direction of the face, and the certainty of face detection. The importance level according to the scene conditions of each divided area is calculated based on, for example, the general object recognition result, the scene discrimination result (blue sky, backlight, evening scene, etc.), the audio level or audio recognition result from the direction of each divided area, and the motion detection information in each divided area.

Next, in step S103, a divided area/areas having an importance level higher than a predetermined threshold is/are determined as a search area, and in step S104, search target angles of pan and tilt required to capture the search area in the angle of view are calculated.

Next, in step S105, the pan and tilt actuation amounts are calculated based on the calculated pan/tilt search target angles, and the tilt rotation unit 204 and the pan rotation unit 205 are actuated. In step S106, it is determined whether or not a subject is present in the search area. If a subject is present in the search area, in step S107, the zoom actuation amount is calculated based on the size of the subject in an image for the subject recognition, and the zoom actuation control unit 302 actuates the zoom unit 301.

Through the above processing, the subject can be searched for.

Although the method of performing subject search by actuating the tilt rotation unit 204, pan rotation unit 205 and zoom unit 301 has been described, the present invention is not limited to this. For example, the image capturing apparatus 101 may be equipped with a plurality of wide-angle lenses, and subject search may be performed by capturing images in all directions at once.

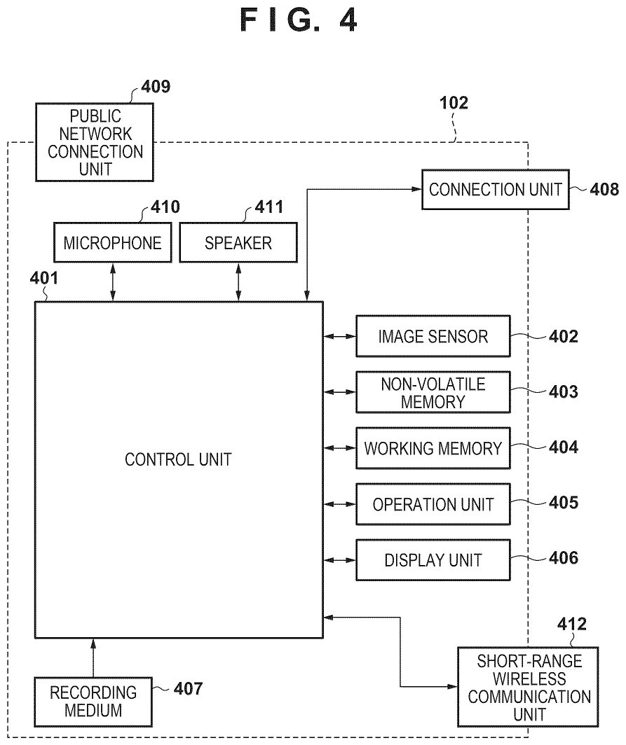

FIG. 4 is a block diagram illustrating the configuration of a smartphone terminal, which is an example of the information processing apparatus 102 in this embodiment.

A control unit 401 controls each unit of the information processing apparatus 102 in accordance with input signals and a program described below. Note that instead of the control unit 401 controlling the entire apparatus, the entire apparatus may be controlled by a plurality of hardware devices sharing the processing load.

An image capturing unit 402 converts light reflected by the subject and converged by the lens included in the image capturing unit 402 into an electric signal, and outputs the digital data obtained by performing noise reduction processing, etc. as image data. The captured image data is stored in a buffer memory included in a working memory 404, and then a predetermined calculation is performed by the control unit 401 and the data is recorded on a recording medium 407.

A non-volatile memory 403 is an electrically erasable and recordable non-volatile memory, and stores an operating system (OS), which is a basic software executed by the control unit 401, and various programs. A program for communicating with the image capturing apparatus 101 is also held in the non-volatile memory 403 and installed as a communication application. The processing of the information processing apparatus 102 in this embodiment is realized by reading a program provided by the communication application. The communication application has a program for utilizing basic functions of the OS installed in the information processing apparatus 102 (e.g., a wireless LAN function or a Bluetooth function). The OS of the information processing apparatus 102 may have a program for realizing the processing in this embodiment.

The working memory 404 is used as a buffer memory for temporarily storing image data generated by the image capturing unit 402 and data received from the image capturing apparatus 101, as an image display memory for a display unit 406, a working area for the control unit 401, and so on.

An operation unit 405 is used to receive instructions from a user for the information processing apparatus 102. The operation unit 405 includes operation members such as a power button for a user to instruct the power supply of the information processing apparatus 102 to be turned on/off, and a touch panel formed on the display unit 406.

The display unit 406 displays image data, characters for interactive operation, etc. The display unit 406 does not necessarily have to be mounted on the information processing apparatus 102. The information processing apparatus 102 may be connected to the display unit 406 and may have at least a display control function for controlling the display of the display unit 406.

The recording medium 407 can record image data output from the image capturing unit 402 and image data received from a communication device. The recording medium 407 may be configured to be detachable from the information processing apparatus 102, or may be built in the information processing apparatus 102. In other words, the information processing apparatus 102 has at least a means for accessing the recording medium 407.

A connection unit 408 is an interface for connecting to the image capturing apparatus 101. The information processing apparatus 102 in this embodiment can exchange data with the image capturing apparatus 101 via the connection unit 408. Note that in this embodiment, the connection unit 408 includes an interface for communicating with the image capturing apparatus 101 via a wireless LAN. The control unit 401 realizes wireless communication with the image capturing apparatus 101 by controlling the connection unit 408.

A public network connection unit 409 is an interface used when performing public wireless communication. The information processing apparatus 102 can make calls and perform data communication with other devices via the public network connection unit 409. When making a call, the control unit 401 inputs and outputs audio signals via a microphone 410 and a speaker 411. In this embodiment, the public network connection unit 409 includes an interface for performing communication using 4G. It is to be noted that other communication methods such as LTE, WiMAX, ADSL, FTTH, and even 5G may be used, not limited to 4G. In addition, the connection unit 408 and the public network connection unit 409 do not necessarily need to be configured as independent hardware, and for example, one antenna may be used for both.

A short-range wireless communication unit 412 is an interface for short-range wireless connection with other communication devices. The information processing apparatus 102 in this embodiment can exchange data with the image capturing apparatus 101 via the short-range wireless communication unit 412.

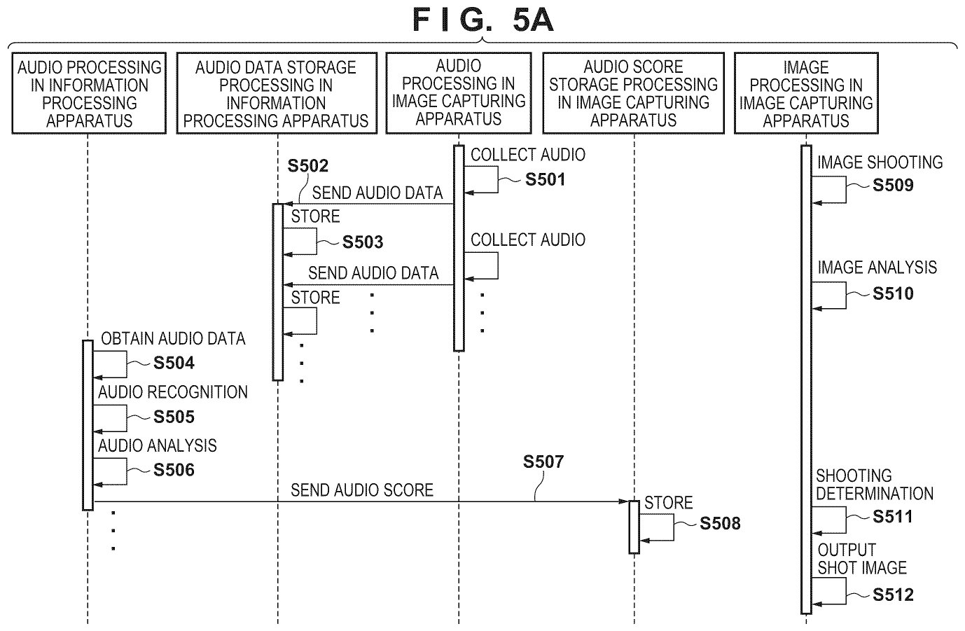

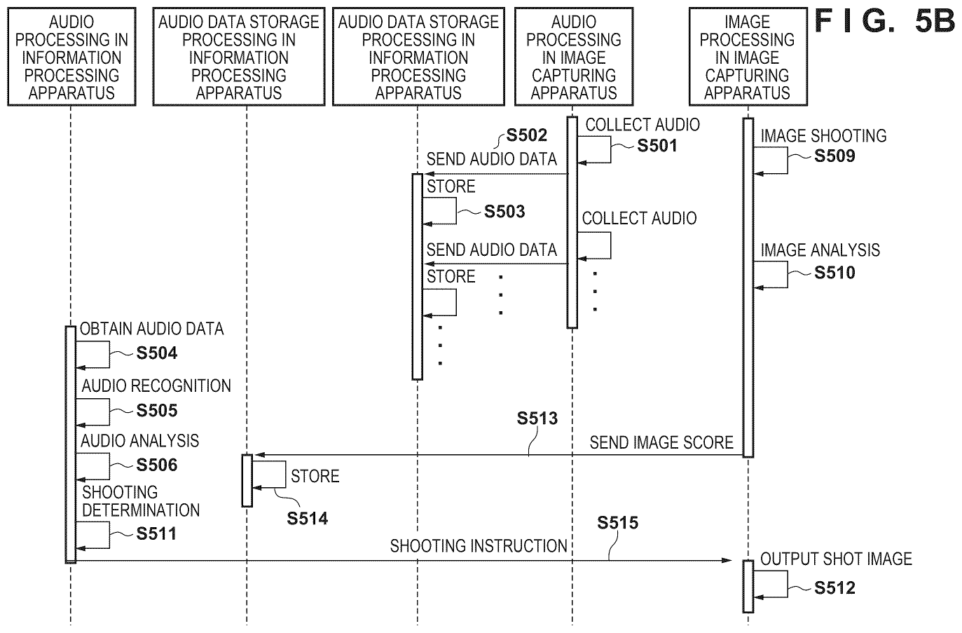

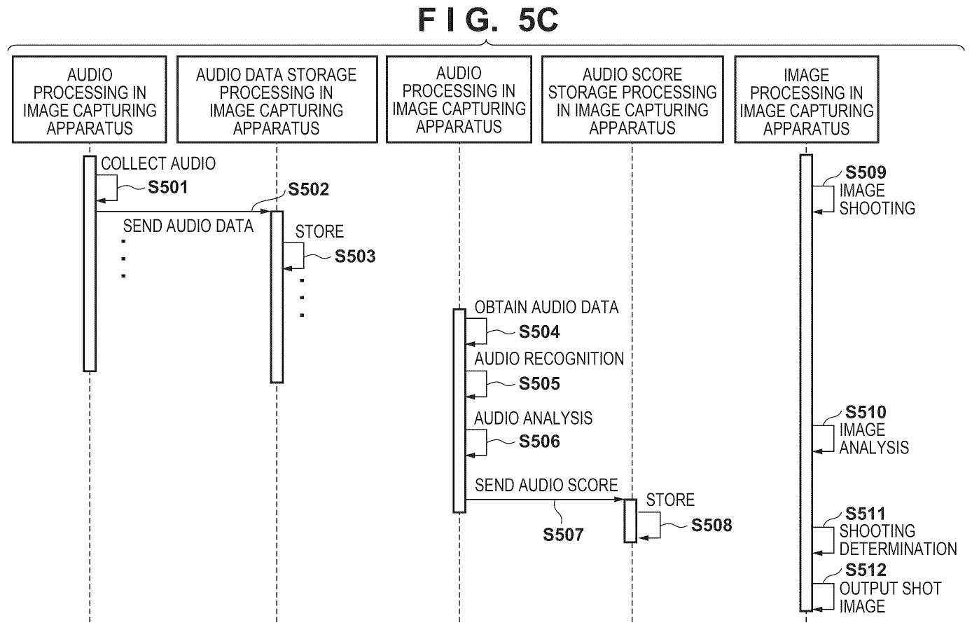

Next, the overall processing flow performed by the image capturing system of this embodiment will be described with reference to FIGS. 5A to 5C.

In the image capturing system of this embodiment, as described above, the control unit 320 of the image capturing apparatus 101 performs subject search processing at a predetermined cycle. In parallel with the subject search processing, the image capturing system of this embodiment performs a series of steps related to shooting as shown in FIG. 5A.

In the image capturing system of this embodiment, the image capturing apparatus 101 generates an image for subject recognition at a predetermined cycle, and quantifies the results of analyzing the image for subject recognition to obtain an image score. In parallel with this, the image capturing apparatus 101 constantly collects audio and transmits the audio data to the information processing apparatus 102. Furthermore, the information processing apparatus 102 analyzes the audio data received from the image capturing apparatus 101 at a predetermined cycle, and transmits an audio score that is a quantification of the audio analysis result to the image capturing apparatus 101. The image capturing apparatus 101 determines whether to perform shooting based on the image score and the audio score, and controls the timing of shooting.

A flow of the above-described processing will be explained in detail using FIG. 5A.

In step S501, the control unit 320 of the image capturing apparatus 101 collects audio. Next, in step S502, the control unit 320 of the image capturing apparatus 101 transmits the collected audio data to the information processing apparatus 102 via the communication unit 318 of the image capturing apparatus 101. At this time, a timestamp is added to the audio data before transmission in order to accurately identify the order of the audio data in subsequent processing. Next, in step S503, the control unit 401 of the information processing apparatus 102 stores the received audio data in the working memory 404. At this time, the audio data is stored in a queue data format so that the order of the audio data can be identified.

The image capturing apparatus 101 and the information processing apparatus 102 repeatedly execute the above-described steps S501 to S503 at a predetermined cycle.

Next, in step S504, the control unit 401 of the information processing apparatus 102 acquires the audio data stored in the queue format in step S503 sequentially from the top. At this time, the timestamp attached to the audio data is referenced, and any audio data that has passed a predetermined time or more at the current time is deleted after acquisition. Next, in step S505, the control unit 401 of the information processing apparatus 102 performs audio recognition using the audio data acquired in step S504. Details of the audio recognition will be described later.

Next, in step S506, the control unit 401 of the information processing apparatus 102 performs audio analysis. In the audio analysis, an audio score is calculated based on the result of the audio recognition in step S505. Details of the audio score will be described later. Next, in step S507, the control unit 401 of the information processing apparatus 102 transmits the audio score obtained in step S506 to the image capturing apparatus 101 via the connection unit 408 of the information processing apparatus 102. Again, in this case, in order to accurately identify the order of the audio scores in subsequent processing, the audio score is assigned the same timestamp as the timestamp assigned to the voice data in step S504 and transmitted. Next, in step S508, the control unit 320 of the image capturing apparatus 101 stores the received audio score in the memory 311.

The image capturing apparatus 101 and the information processing apparatus 102 repeatedly execute the above-described series of processes in steps S504 to S508 at a predetermined cycle.

Meanwhile, in step S509, the image capturing unit 306 of the image capturing apparatus 101 performs shooting.

Here, the shooting processing in this embodiment will be described. First, the image capturing unit 306 captures images at a predetermined cycle to generate images for subject recognition. The images for subject recognition generated here are used for ongoing subject search processing and for image analysis in step S510, which will be described later. Next, the generated images for subject recognition are stored in memory 311.

Next, in step S510, the control unit 320 of the image capturing apparatus 101 performs image analysis. In the image analysis, the image shot in step S509 is analyzed to calculate an image score. The image score is calculated using the number of faces of the person who is the subject in the current image for subject recognition, the degree of smile on the face, the degree of eye closure, the face position, the face angle, and the gaze angle. Once the image score calculation is completed, the image for subject recognition is deleted from the memory 311. Note that in addition to the subject detection result described above, the image score may also be calculated using an animal detection result, a general object recognition result, a scene discrimination result, etc.

Next, in step S511, the control unit 320 of the image capturing apparatus 101 determines whether to output the captured image. Here, it is determined whether the sum of the audio score stored in step S508 and the image score calculated in step S510 exceeds a threshold Th1. If the result of the determination is that the sum exceeds the threshold Th1, the process proceeds to step S512. On the other hand, if the sum does not exceed the threshold Th1, the process ends. Note that in this embodiment, the image score and the audio score are both normalized to have equal values in a range with a minimum value of 0 and a maximum value of 100, so that they can be added together.

If it is determined in step S511 that the sum exceeds the threshold value Th1, the shot image is output in step S512. The output of the shot image here means performing a shooting operation to generate a shot image and storing it in a storage medium, and is different from the image shooting in step S509.

The image capturing system in this embodiment performs the above-described processes of steps S501 to S512 in parallel.

Although the method of determining whether the sum of the image score and the audio score exceeds the threshold value Th1 in step S511 has been described, the present invention is not limited to this. For example, a method of determining whether the image score and the audio score exceed different threshold values and determining whether at least one of them exceeds a threshold value may be used.

Furthermore, the audio collection processing may be performed by the information processing apparatus 102 rather than the image capturing apparatus 101. In that case, however, there is a possibility that the collected audio is not audio around the image capturing apparatus 101. Therefore, in order to shoot a person who made the utterance within the angle of view, this is applicable as long as the distance between the image capturing apparatus 101 and the information processing apparatus 102 is within a predetermined distance. Furthermore, audio may be collected by a microphone connected to the information processing apparatus 102 by wire or wirelessly.

In the process shown in FIG. 5A, the image capturing apparatus 101 is configured to make the shooting decision as to whether or not to output the shot image in step S511, but as shown in FIG. 5B, this may also be made in the information processing apparatus 102. In FIG. 5B, the audio score is not transmitted to the image capturing apparatus 101, and the image score, which is the result of the image analysis in step S510, is transmitted from the image capturing apparatus 101 to the information processing apparatus 102 and stored. Then, in step S511, the information processing apparatus 102 makes a shooting decision based on the image score and the audio score, and if shooting is to be performed, a shooting instruction is output to the image capturing apparatus 101 in step S515, where shooting is performed. In this way, the shooting timing is controlled based on the image score and audio score.

Furthermore, in the processing of FIG. 5A, the audio recognition in step S505 and the audio analysis in step S506 are performed by the information processing apparatus 102. However, as shown in FIG. 5C, these may be performed by the image capturing apparatus 101.

In this case, it is necessary to have the audio processing unit 310 of the image capturing apparatus 101 learn audio patterns of several words based on a large amount of audio data in advance. Therefore, the configuration in which the audio recognition in step S505 is performed by the image capturing apparatus 101 is applicable when the pre-learned audio patterns can be installed in the audio processing unit 310 of the image capturing apparatus 101. In contrast, in a configuration in which the audio recognition in step S505 is performed by the information processing apparatus 102, or a configuration in which the information processing apparatus 102 transmits audio data to an external server, software, cloud service, or the like for audio recognition and receives the audio recognition results, it is possible to perform highly accurate analysis using audio recognition technology that is constantly evolving.

Hereinafter, in this embodiment, the method shown in FIG. 5A will be described.

Next, the processes in steps S505 and S506 performed by the information processing apparatus 102 in this embodiment will be described in detail.

There are three methods for calculating the audio score. The first method is based on human voice detection, the second method is based on topic detection, and the third method is based on trigger word detection registered by the user. The specific processing of each method will be described later. In this embodiment, the audio score is obtained by summing the points calculated by these three methods, then the sum is normalized in a range with a minimum value of 0 and a maximum value of 100. By performing judgement based on the sum of these three points, it is possible to detect scenes with higher accuracy than when performing judgment individually for the point obtained by each method. In this embodiment, if the sum of the three points exceeds 100, the audio score is normalized to be 100.

The control unit 401 of the information processing apparatus 102 performs the calculation processes of the three scores at predetermined time intervals. In this embodiment, for example, the first method is performed at 2-second intervals, the second method at 10-second intervals, and the third method at 2-second intervals. That is, in this embodiment, the calculation process of adding up and normalizing the points obtained by the first and third methods is performed at 2-second intervals, and the calculation process of adding up and normalizing the points obtained by all three methods is performed at 10-second intervals.

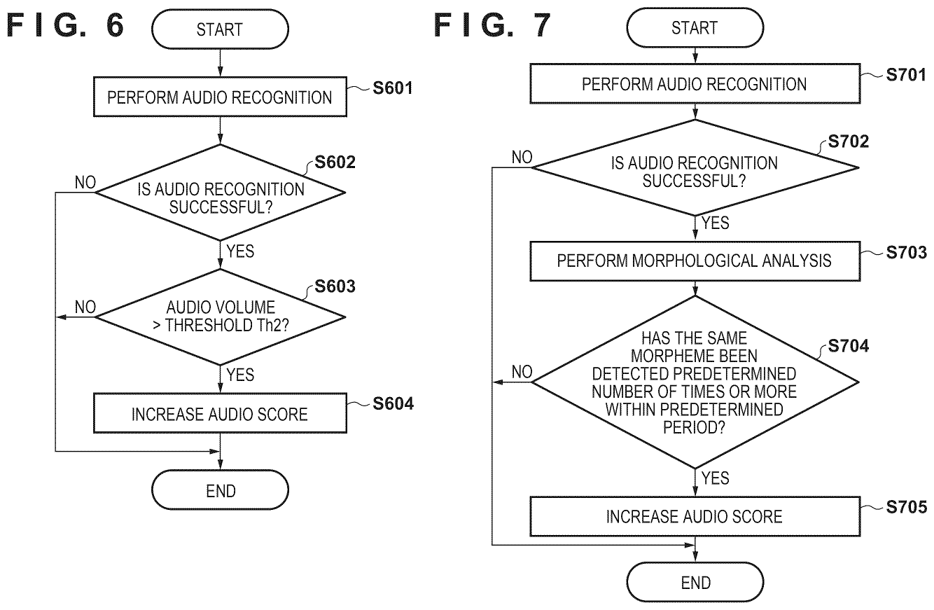

First, the first method, which is a method of calculating an audio score by detecting human voices, will be described with reference to FIG. 6.

This method utilizes the fact that audio recognition is performed when the input audio is a human voice, but is not performed when it is noise such as the sound of a vacuum cleaner or footsteps. This is because if audio recognition is performed, it can be inferred that a human is having a conversation and that it is highly likely that it is the right time to perform shooting.

In this embodiment, the control unit 401 of the information processing apparatus 102 executes the following processing at a predetermined time interval (for example, every two seconds).

First, in step S601, audio recognition is performed. An example of the processing flow of audio recognition is described below, but the method of audio recognition is not limited to this. First, features such as the frequency and strength of the audio are extracted and converted into quantitative values. Next, based on a learning pattern that has been learned in advance based on a large amount of audio data, a phoneme that is closest to the extracted feature is extracted. A phoneme is the smallest unit of sound. The number and types of phonemes vary depending on the language. For example, in English, phonemes are vowels and consonants, while in Japanese, phonemes include syllabic nasals, double consonants, and long sounds in addition to vowels and consonants. Next, pattern matching is performed using dictionary data in which pronunciations and words are registered, and the phonemes are converted into words. Audio recognition is performed according to the above procedure.

The audio recognized here is not limited to Japanese or English, and may be other languages. The audio recognized here is not limited to human voices, and may be a predetermined type of voice, for example, an animal sounds. However, the second and third methods described below are premised on the audio being a human voice. Therefore, only when the sound recognized in the first method is animal sounds, the audio score is not the sum of the three points, but is a value obtained by multiplying the point calculated by the first method by a predetermined value. However, the audio score is not limited to this, and may be a value obtained by adding a predetermined value to the point calculated by the first method.

An example of the processing flow for determining animal sounds is described below, but the determination method is not limited to this. First, the frequency spectrum of the collected audio is calculated and converted into a voiceprint image. The frequency spectrum is the Fourier transform of the sound, and represents the frequency components of the sound. Next, based on a learning pattern that has been learned in advance from a large amount of animal voiceprint image data, it is determined whether the converted voiceprint image is an animal sounds or not. Through the above procedure, animal sounds are recognized in audio recognition.

Next, in step S602, it is determined whether the audio recognition is successful in step S601. If the audio recognition is successful, the process proceeds to step S603, and if audio recognition is not successful, the processing ends without adding any points to the audio score.

Next, in step S603, it is determined whether the volume of the audio exceeds a threshold Th2. If the volume of the audio exceeds the threshold Th2, the process proceeds to step S604, and if the volume of the audio does not exceed the threshold Th2, the processing ends without adding any points to the audio score.

Then, if it is determined in step S602 that the audio recognition was successful and it is determined in step S603 that the volume of the audio exceeds the threshold Th2, the audio score is increased in step S604. In this embodiment, the points to be added to the audio score is determined in four stages: +25 points, +50 points, +75 points, and +100 points, so that the points increases more as the volume of the audio increases.

Through the processing described above, if the audio recognition is successful and the volume of the audio exceeds a certain threshold, the audio score is increased according to the volume of the audio.

This makes it possible to only increase the audio score when there is excitement due to human voices, without the audio score being increased due to loud noises or everyday sounds such as the sound of a vacuum cleaner or footsteps.

In this embodiment, the case has been described where the audio recognition is performed within the information processing apparatus 102, but the communication unit may transmit audio data to an external server, software, cloud service, etc. for audio recognition and receive the audio recognition result.

Next, the second method, which is a method of calculating the audio score by detecting topics, will be explained using FIG. 7.

This method utilizes the fact that when the same word is detected a predetermined number of times or more in a text sentence of audio detected within a predetermined time period, it is possible to infer that the conversation is lively on a topic related to that word.

In this embodiment, the control unit 401 of the information processing apparatus 102 performs the following processing at a predetermined time interval (for example, every 10 seconds).

First, audio recognition is performed in step S701. The procedure of the audio recognition process is the same as that in step S601, and therefore a description thereof will be omitted.

Next, in step S702, it is determined whether audio recognition is successful in step S701. If audio recognition is successful, the process proceeds to S703, and if audio recognition is not successful, the processing ends without adding any points to the audio score.

Next, in step S703, morphological analysis is performed using the text obtained by audio recognition. A morpheme is the smallest unit of a word having a meaning, and morphological analysis is to divide a sentence into morphemes and determine part of speech information such as nouns and verbs. For example, in the case of a Japanese sentence “Watashi wa akai ringo wo tabe masu”, it is divided into “Watashi”, “wa”, “akai”, “ringo”, “wo”, “tabe”, and “masu”, and “Watashi” is determined to be a pronoun, “wa” is a particle, “akai” is an adjective, “ringo” is a noun, “tabe” is a verb, and “masu” is an auxiliary verb. Note that in this embodiment, morphological analysis is exemplified using a Japanese text sentence, but is not limited to Japanese. For example, an English sentence “I eat a red apple” is divided into “I”, “eat”, “a”, “red”, and “apple”, with “I” identified as a pronoun, “eat” as a verb, “a” as an article, “red” as an adjective, and “apple” as a noun. Thus, morphological analysis is possible even for sentences in languages other than Japanese.

Next, in step S704, it is determined whether any identical morpheme has been detected a predetermined number of times within a predetermined period of time. In this embodiment, the predetermined period of time is 10 seconds as described above. The morphemes detected here are the morphemes determined to be nouns in step S703. For example, in a sentence “Dogs are cute. Both big dogs and small dogs are cute,” it can be determined that the same morpheme “dog” has been detected three times.

In this way, if any identical morpheme is detected a predetermined number of times within a predetermined period of time in step S704, the process proceeds to step S705, and if it is not detected, the processing ends without adding any points to the audio score.

Then, in step S704, if any same morpheme is detected a predetermined number of times or more within a predetermined period of time, it is determined that the conversation is lively on a topic related to that morpheme, and the audio score is increased in step S705. In this embodiment, the more times the morpheme is detected, the higher the points to be added becomes, and if the detection number is two, 25 points are added, and if it is three or more, 50 points are added.

By the above-described processing, it is possible to detect that the conversation is lively on a certain topic.

In this embodiment, the case where morphological analysis is performed within the information processing apparatus 102 has been described, but the communication unit may transmit audio data to an external server, software, cloud service, etc. for morphological analysis and receive the results of the morphological analysis.

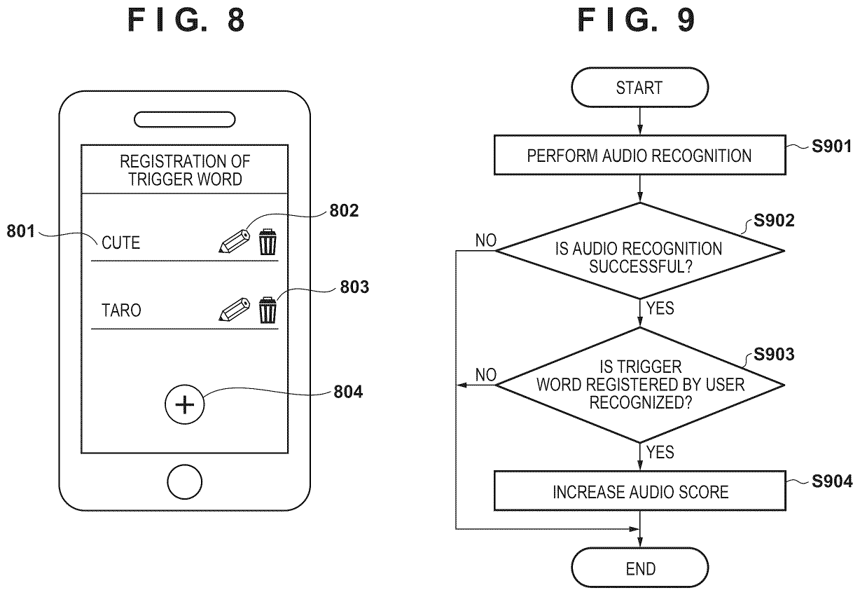

Next, a third method, which is a method of detecting a trigger word/words registered by a user and calculating an audio score, will be described with reference to FIGS. 8 and 9.

FIG. 8 shows a screen for registering a trigger word, which is displayed on the display unit 406 of the information processing apparatus 102 in this embodiment. The components of the screen are described below.

First, a reference numeral 801 indicates a trigger word. When a registered trigger word is recognized, an audio score is increased. A trigger word is a word that is often uttered at the time when the user wants to be shot. This makes it possible to perform shooting by using a word used in natural everyday conversations as a trigger without the user being aware that they are being shot.

For example, by registering the word “cute” as the first example of trigger word 801, it is possible to register in the information processing apparatus 102 in advance so that a photo will be taken in response to a parent saying “cute” the moment their child says or does something cute.

In addition, if the child's name, “Taro,” is registered as the second trigger word 801, it is possible to register in advance that a photo will be taken the moment the parent calls the child's name, “Taro.” In this way, the user can freely register trigger words.

Reference numeral 802 is an edit button, which when pressed allows the user to edit a trigger word that has already been registered.

Reference numeral 803 is a delete button, which when pressed allows the user to delete a trigger word that has already been registered.

And reference numeral 804 is an add button, which when pressed allows the user to add and register a new trigger word.

FIG. 9 is a flowchart illustrating the processing low for detecting trigger words registered by a user and calculating an audio score.

In this embodiment, the control unit 401 of the information processing apparatus 102 executes the following processing at a predetermined time interval (e.g., every 2 seconds).

First, in step S901, audio recognition is performed. The procedure of the audio recognition process is the same as that in step S601, and therefore a description thereof will be omitted.

Next, in step S902, it is determined whether audio recognition in step S901 is successful. If audio recognition is successful, the process proceeds to step S903, and if audio recognition is not successful, the processing ends without adding any points to the audio score.

In step S903, it is determined whether a trigger word registered by the user in advance is detected from the text obtained by the audio recognition. If it is detected, the process proceeds to step S904. If it is not detected, the processing ends without adding any points to the audio score.

Then, if it is determined in step S903 that a trigger word is detected, the audio score is increased in step S904. In this embodiment, for example, the number of points to be added when a trigger word is detected is set to +100 points.

According to the method described above, a user can issue a shooting instruction to an image capturing apparatus using a trigger word that is freely registered by the user.

With the processing flow described above, the image capturing system of this embodiment uses audio analysis in addition to image analysis, making it possible to recognize when a place is lively or when conversation is lively, something that image analysis alone cannot do. This makes it possible to prevent from missing shots.

In the image capturing system of the present embodiment, the image capturing apparatus is provided with pan, tilt, and zoom functions, which allows autonomous searching of a subject person and automatic adjustment of the imaging angle of view. However, the present invention can also be applied to image capturing apparatuses that do not have components that realize such pan, tilt, and zoom functions. For example, even in an image capturing system that uses an image capturing apparatus that captures images with a fixed angle of view and zoom magnification, such as a surveillance camera, automatic shooting that combines image analysis and audio analysis is useful, and the present invention can be applied.

In addition, in the automatic shooting in this embodiment, it has been described that shooting is automatically performed based on the image score and the audio score, but the conditions for shooting are not limited to this. For example, the current zoom magnification, the elapsed time since the previous shooting, the shooting time, etc. may also be used.

In addition, although it has been described that the audio score in this embodiment is a value obtained by adding up the three scores calculated by the three calculation methods, it is possible to use one or more of them in combination, rather than performing all of the detections by the three methods. In that case, the points calculated by each method and the calculation method of the audio score using those values are not limited to those described above, and may be changed as appropriate.

### OTHER EMBODIMENTS

The present invention may be applied to a system made up of a plurality of devices, or to an apparatus made up of a single device.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-223263, filed Dec. 28, 2023 which is hereby incorporated by reference herein in its entirety.

What is claimed is:

1. A control system that controls shooting timing of an image to be recorded by an image capturing apparatus, comprising one or more processors and/or circuitry which function as:
an image analysis unit that analyzes images obtained by the image capturing apparatus performing shooting repeatedly;
an audio analysis unit that analyzes audio collected by an audio collection unit; and
a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.

2. The control system according to claim 1, wherein the audio analysis unit analyzes and quantifies characteristics of the audio and outputs a numerical audio score.

3. The control system according to claim 2, wherein the audio analysis unit detects a predetermined type of audio from the audio, and increase the audio score if a volume of the detected predetermined type of audio is greater than a predetermined threshold.

4. The control system according to claim 3, wherein the audio analysis unit adds a larger value to the audio score as the volume of the predetermined type of audio increases.

5. The control system according to claim 3, wherein the predetermined type of audio voice is a human voice.

6. The control system according to claim 2, wherein the audio analysis unit increases the audio score if a same morpheme is repeatedly detected from the audio a predetermined number of times or more within a predetermined period of time.

7. The control system according to claim 6, wherein the audio analysis unit adds a larger value to the audio score in a case where a number of times a morpheme is repeatedly detected within a predetermined period of time is a first number of times than in a case where the number of times is a second number of times that is smaller than the first number of times.

8. The control system according to claim 2, wherein the audio analysis unit increases the audio score if a predetermined word is detected from the audio.

9. An image capturing system comprising:
a control apparatus that includes an audio analysis unit that analyzes audio collected by an audio collection unit;
an image capturing apparatus that includes:
an image sensor that shoots an image;
an image analysis unit that analyzes images obtained by the image sensor performing shooting repeatedly; and
a control unit that determines whether or not to shoot an image to be recorded based on an image analysis result obtained by the image analysis unit and an audio analysis result by the audio analysis unit, and instructs the image sensor to shoot an image to be recorded if it is determined that an image should be shot, and
a communication unit that communicates between the image capturing apparatus and the control apparatus,
wherein the audio analysis unit, the image analysis unit, and the control unit are implemented by one or more processors, circuitry or a combination thereof.

10. A control unit that controls shooting timing of an image to be recorded by an image capturing apparatus, comprising one or more processors and/or circuitry which function as:
an image analysis unit that analyzes images obtained by the image capturing apparatus performing shooting repeatedly;
an audio analysis unit that analyzes audio collected by an audio collection unit; and
a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.

11. The control unit according to claim 10, wherein the audio analysis unit analyzes and quantifies characteristics of the audio and outputs a numerical audio score.

12. The control unit according to claim 11, wherein the audio analysis unit detects a predetermined type of audio from the audio, and increase the audio score if a volume of the detected predetermined type of audio is greater than a predetermined threshold.

13. The control unit according to claim 12, wherein the audio analysis unit adds a larger value to the audio score as the volume of the predetermined type of audio increases.

14. The control unit according to claim 12, wherein the predetermined type of audio voice is a human voice.

15. The control unit according to claim 11, wherein the audio analysis unit increases the audio score if a same morpheme is repeatedly detected from the audio a predetermined number of times or more within a predetermined period of time.

16. The control unit according to claim 15, wherein the audio analysis unit adds a larger value to the audio score in a case where a number of times a morpheme is repeatedly detected within a predetermined period of time is a first number of times than in a case where the number of times is a second number of times that is smaller than the first number of times.

17. The control unit according to claim 11, wherein the audio analysis unit increases the audio score if a predetermined word is detected from the audio.

18. An image capturing apparatus comprising:
an image sensor that shoots an image; and
a control unit that controls shooting timing of an image to be recorded by the image capturing apparatus, comprising one or more processors and/or circuitry which function as:
an image analysis unit that analyzes images obtained by the image capturing apparatus performing shooting repeatedly;
an audio analysis unit that analyzes audio collected by an audio collection unit; and
a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.

19. An information processing apparatus comprising:
a control unit that controls shooting timing of an image to be recorded by an image capturing apparatus, comprising one or more processors and/or circuitry which function as:
an image analysis unit that analyzes images obtained by the image capturing apparatus performing shooting repeatedly;
an audio analysis unit that analyzes audio collected by an audio collection unit; and
a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot, and
a communication unit that communicates with the image capturing apparatus.

20. A control method that controls shooting timing of an image to be recorded by an image capturing apparatus, comprising:
analyzing images obtained by the image capturing apparatus performing shooting repeatedly;
analyzing audio collected by an audio collection unit; and
determining whether or not to shoot an image to be recorded based on the image analysis result and the audio analysis result, and instructing the image capturing apparatus to shoot an image to be recorded if it is determined that an image should be shot.

21. A non-transitory computer-readable storage medium, the storage medium storing a program that is executable by the computer, wherein the program includes program code for causing the computer to function as a control system that controls shooting timing of an image to be recorded by an image capturing apparatus, comprising:
an image analysis unit that analyzes images obtained by the image capturing apparatus performing shooting repeatedly;
an audio analysis unit that analyzes audio collected by an audio collection unit; and
a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.

22. A non-transitory computer-readable storage medium, the storage medium storing a program that is executable by the computer, wherein the program includes program code for causing the computer to function as a control unit that controls shooting timing of an image to be recorded by an image capturing apparatus, comprising:
an image analysis unit that analyzes images obtained by the image capturing apparatus performing shooting repeatedly;
an audio analysis unit that analyzes audio collected by an audio collection unit; and
a control unit that determines whether or not to shoot an image to be recorded based on an image analysis result obtained by the image analysis unit and an audio analysis result by the audio analysis unit, and instructs the image capturing apparatus to shoot an image to be recorded if it is determined that an image should be shot.
